(19) United States
(12) Patent Application Publication
(10) Pub. No.: US 2018/0219242 A1
(43) Pub. Date: Aug. 2, 2018

(54) SOLID OXIDE FUEL CELL ARRAY

(71) Applicant: TOTO LTD., Kitakyushu-shi (JP)

(72) Inventors: Naoki WATANABE, Fukuoka (JP); Takuya HOSHIKO, Fukuoka (JP); Masaru KUBOTA, Fukuoka (JP); Hajime OMURA, Fukuoka (JP)

(21) Appl. No.: 15/883,945

(22) Filed: Jan. 30, 2018

(30) Foreign Application Priority Data
Jan. 31, 2017 (JP) 2017-014947
Jan. 24, 2018 (JP) 2018-009780

(51) Int. Cl. H01M 8/243; H01M 8/1246; H01M 8/1233; H01M 4/86

(52) U.S. Cl. CPC H01M 8/243; H01M 8/1246; H01M 2008/1293; H01M 4/8621; H01M 8/1233

(57) ABSTRACT

A solid oxide fuel cell array has pairs of a first connection member and a second connection member. Each pair electrically connects two adjacent first and second fuel cells to electrically connect the plurality of fuel cells in series. The second fuel cell has the first connection member connected to the outer side electrode layer of the second fuel cell at a distance D1 measured from the upper terminal end of the outer side electrode layer of the second fuel cell and has the second connection member connected to the outside side electrode layer of the second fuel cell at a distance D2 measured from the lower terminal end of the outer side electrode of the second fuel cell. The distance D2 is longer than the distance D1.

### BACKGROUND OF THE INVENTION

### 1. Field of the Invention

The present invention relates to a fuel cell array. In particular, the present invention relates to a solid oxide fuel cell array that generates electricity by reacting a fuel gas with an oxidant gas.

### 2. Description of the Related Art

A solid oxide fuel cell (SOFC) is an electricity-generating device that employs an oxide ion conducting solid electrolyte as an electrolyte, and includes a fuel cell array with electrodes attached to both sides of each fuel cell. A solid oxide fuel cell device has a plurality of fuel cells arranged inside a module, and a fuel gas is supplied to one of the electrodes (fuel electrode) of the fuel cell, while an oxidant gas (air, oxygen, or the like) is supplied to the other electrode (air electrode), causing an electricity-generating reaction to take place to produce electrical power. The solid oxide fuel cell device operates at relatively high temperatures on the order of 700-1,000° C.

Patent Reference 1 discloses a tubular fuel cell having a cylindrical or flattened cylindrical shape that is used as a fuel cell in such a solid oxide fuel cell device. The required power can be generated by electrically connecting a plurality of fuel cells in series to generate electricity.

However, tubular fuel cells have a problem in that the migration distance for electrons within the electrodes is great, because the electrodes extend in the longitudinal axial direction, and this can cause a decrease in the electricity-generating efficiency of the fuel cell. Patent Reference 1 describes a method for electrically connecting a plurality of fuel cells in series in which an upper end side of an air electrode (+) of a first fuel cell and an upper end side of a fuel electrode (−) of a second fuel cell adjacent thereto are connected by a first connection member, and a lower end side of the air electrode (+) of the first fuel cell and a lower end side of the fuel electrode (−) of the second fuel cell are connected by a second connection member. This is referred to as “double-end current collection” structure. According to this structure, electrical current generated by the fuel cells is distributed to the connection members provided to the upper end side and the lower end side of the fuel cells, and then extracted to the outside. Therefore, the electrical current migrating distance can be shortened, and the electrical resistance can be reduced. This makes it possible to increase the power-generating efficiency of the fuel cell.

### PRIOR ART REFERENCES

### Patent References

Patent Reference 1: Japanese Patent No. 5578332

### SUMMARY OF THE INVENTION

### Problems to be Solved by the Invention

However, fuel gas is typically supplied from the lower end of a tubular fuel cell to an internal flow channel (fuel gas flow channel) of the fuel cell. Hydrogen contained in the supplied fuel gas is consumed in the electricity-generating reaction. Therefore, the density of the hydrogen contained in the fuel gas is lower in the downstream side of the fuel gas flow channel than in the upstream side (in other words, it is lower at the upper end side than at the lower end side). Accordingly, the electricity-generating reaction in the fuel cell occurs most actively at the lowermost end of the fuel cell. If the double-end current collection structure is employed in such a fuel cell device, the electricity-generating reaction becomes concentrated at the area around the connection member provided at the upstream side of the fuel gas flow channel (i.e., the lower end side of the fuel cell), depending on the amount of fuel gas supplied, the current collecting method of the fuel cell, and the amount of current extracted. That is to say, the present inventors discovered that there is a risk of concentration of electrical current. The present inventors thought that the cause for this concentration of electrical current is an overlapping of the zone where the electricity-generating reaction is most active and the zone where electrical current is extracted by the connection member. The concentration of electrical current causes degradation of the fuel cell, and this is a factor leading to various problems such as a decrease in durability.

The present inventors conceived of raising the electrical resistance on the upstream side of the fuel gas flow channel, in order to reduce the concentration of electrical current on the upstream side of the gas flow channel.

The present invention provides a highly durable solid oxide fuel cell array having a plurality of tubular fuel cells and mitigates the concentration of electrical current.

### Means for Solving the Problems

The solid oxide fuel cell array according to the present invention is a solid oxide fuel cell array provided with a plurality of fuel cells each including a tubular inner side electrode layer through which a fuel gas flows, an outer side electrode layer formed on the outer side of the inner side electrode layer along which an oxidant gas flows, and a solid electrolyte layer formed between the inner side electrode layer and the outer side electrode layer. The fuel gas is supplied from one end side of the plurality of fuel cells to the other end side, and a first fuel cell which is any one of the plurality of fuel cells, and a second fuel cell that is adjacent to the first fuel cell, are electrically connected by a first connection member and a second connection member. The first fuel cell has the first connection member disposed at the aforementioned other end side of the inner side electrode layer and the second connection member disposed at the aforementioned one end side of the inner side electrode layer. The second fuel cell has the first connection member disposed at the other end side of the outer side electrode layer and the second connection member disposed at the aforementioned one end side of the outer side electrode layer. The second connection member is disposed at a greater distance in the longitudinal axial direction measured from a terminal end of the aforementioned one end of the outer side electrode layer to a connection zone where the second connection member is connected, than the distance in the longitudinal axial direction measured from a terminal end of the other end side of the outer side electrode layer to a connection zone where the first connection member is connected.

According to the present invention, the concentration of electrical current is prevented from occurring at one end side of the fuel cell, thus making it possible to achieve a highly durable fuel cell array.

In an embodiment of the present invention, the second connection member is advantageously disposed in a position in the central portion in the longitudinal axial direction of the outer side electrode layer of the second fuel cell, or in a position shifted from the central portion toward the aforementioned one end side of the outer side electrode layer.

According to this embodiment, it is possible to separate the current collection zone from the one end side of the fuel side where current concentration readily occurs. This embodiment reduces the occurrence of current concentration, making it possible to provide a highly durable fuel cell array.

In an embodiment of the present invention, the first connection member and the second connection member each have connecting portions for electrically connecting the inner side electrode layer of the first fuel cell and the outer side electrode layer of the second fuel cell, and an extended portion that electrically connects the respective connecting portions. The extended portion of the second connection member is longer than the extended portion of the first connection member.

According to this embodiment, the extended portion of the second connection member has a longer conductive pathway, which makes it possible to increase the resistance. Therefore, it becomes possible to limit the amount of current passing through the extended portion of the second connection member. It is thus possible to reduce the electrical current concentration at the one end side of the fuel cell, making it possible to provide a highly durable fuel cell array.

In an embodiment of the present invention, the resistance at one end side of either the inner side electrode layer or the outer side electrode layer of the fuel cell is greater than that of the other end side of the fuel cell.

According to this embodiment, the amount of electricity flowing to the one end side of the fuel cell can be restricted. As a result, it is possible to provide a highly durable fuel cell array that mitigates the concentration of electrical current at the one end side of the fuel cell.

In an embodiment of the present invention, it is advantageous for the solid electrolyte layer of the fuel cell to have a greater resistance at the one end side of the solid electrolyte layer than at the other end side of the solid electrolyte layer.

According to this embodiment, it is possible to limit the generated electrical current at the one end side of the fuel cell. Accordingly, it is possible to provide a highly durable fuel cell array that mitigates the concentration of electrical current at the one end side of the fuel cell.

In an embodiment of the present invention, the outer side electrode layer of the fuel cell has a resistance at the one end side of the fuel cell of at least 1.5-fold and less than 20-fold the resistance at the other end side thereof. In addition, it is advantageous for the solid electrolyte layer of the fuel cell to have a resistance at the one end side of the fuel cell that is at least 1-fold and less than 2-fold the resistance at the other end side thereof.

According to this embodiment, it is possible to mitigate the occurrence of concentration of electrical current at the one end side by adjusting the resistance of the outer side electrode layer that serves as the conductive pathway for the electrons. Moreover, the solid electrolyte layer is able to mitigate the generated electrical current at the one end side, because the electrical resistance at the one end side is greater than that of the other end side in the longitudinal axial direction of the fuel cell. This makes it possible to provide a highly durable fuel cell array.

In an embodiment of the present invention, the inner side electrode layer of the fuel cell has a resistance at the one end side of the fuel cell of at least 1-fold and less than 5-fold the resistance at the other end side thereof. In addition, it is advantageous for the solid electrolyte layer of the fuel cell to have a resistance at the one end side of the fuel cell that is at least 1-fold and less than 2-fold the resistance at the other end side thereof.

According to this embodiment, it is possible to mitigate the occurrence of concentration of electrical current at the one end side by adjusting the resistance of the inner side electrode layer that serves as the conductive pathway for the electrons. Moreover, the solid electrolyte layer is able to mitigate the generated electrical current at the one end side, because the electrical resistance at the one end side is greater than that of the other end side in the longitudinal axial direction of the fuel cell. This makes it possible to provide a highly durable fuel cell array.

In an embodiment of the present invention, in the outer side electrode layer, it is advantageous for the film thickness (d4) of the other end side of the outer side electrode layer of the fuel cell and the film thickness (d3) of the one end side of the outer side electrode layer to satisfy the inequality d4>d3.

According to this embodiment, by increasing the film thickness of the outer side electrode layer, the cross-sectional surface area increases where electrons migrate in the longitudinal axial direction of the fuel cell, and thus decreases the resistance thereof. This makes it possible to mitigate the concentration of electrical current at the one end side of the fuel cell, because the resistance at the other end of the fuel cell is relatively lower than at the one end side of the fuel cell.

In an embodiment of the present invention, it is advantageous for the film thickness (d2) of the other end side of the solid electrolyte layer of the fuel cell and the film thickness (d1) of the one end side of the solid electrolyte layer to satisfy the inequality d1>d2.

According to this embodiment, when electricity is generated in the solid oxide fuel cell array, the oxide ions migrate in the film thickness direction of the solid electrolyte layer. That is to say, the greater the film thickness of the solid electrolyte layer, the greater the migration distance traversed by the ions, and the greater the resistance. This makes it possible to mitigate the concentration of electrical current at the one end side of the fuel cell, because the resistance at the one end side of the fuel cell becomes greater than that of the other end side of the fuel cell.

### Advantageous Effects of the Invention

The present invention provides a highly durable solid oxide fuel cell array having a plurality of tubular fuel cells able to mitigate the occurrence of electrical current concentration.

### BRIEF DESCRIPTION OF THE DRAWINGS

FIG. 1 is a graph illustrating the results of a simulation showing current density at height positions along a fuel cell in the case of a double-end current collection structure according to the present invention, in which the connection member of the fuel cell is shifted from the one end side toward the other end side, and in the case of a prior art double-end current collection structure.

FIG. 2 is a side view of a fuel cell array in an embodiment of the present invention.

FIG. 3 is a side view of a fuel cell array in an embodiment of the present invention.

FIG. 4 is an oblique view of a connection member in an embodiment of the present invention.

FIG. 5 is a side view of a fuel cell in an embodiment of the present invention.

FIG. 6 is a partial side view of a fuel cell in an embodiment of the present invention.

FIG. 7 is a graph illustrating the results of simulation showing current density at height positions along a fuel cell in the first embodiment of the present invention.

FIG. 8 is a side view of a fuel cell array in the first embodiment of the present invention.

FIG. 9 is a side view of a fuel cell array in a case where the position of the connection member differs from that of the first embodiment of the present invention.

FIG. 10 is a graph illustrating the results of simulation showing current density at height positions along a fuel cell in the second embodiment of the present invention.

FIG. 11 is a side view of a fuel cell array in the second embodiment of the present invention.

FIG. 12 is a side view of a fuel cell array in a case where the position of the connection member differs from that of the second embodiment of the present invention.

FIG. 13 is a graph illustrating the results of simulation showing current density at height positions along a fuel cell in the third embodiment of the present invention.

FIG. 14 is a side view of a fuel cell array in the second embodiment of the present invention.

FIG. 15 is a side view of a fuel cell array in a case where the position of the connection member differs from that of the third embodiment of the present invention.

FIG. 16 is a side view illustrating a prior art fuel cell array.

### DETAILED DESCRIPTION OF THE PREFERRED EMBODIMENTS

The embodiments of the invention will be explained in detail with reference to the drawings. Based on the descriptions below, many improvements and other embodiments of the present invention are obvious to any person skilled in the art. Therefore, the following descriptions are to be interpreted only as examples, and these have been provided for the purpose of teaching to persons skilled in the art the preferred embodiments for implementing the present invention. The details of structure and/or function thereof can be substantively modified without deviating from the spirit of the present invention.

The solid oxide fuel cell array according to the present invention is a solid oxide fuel cell array provided with a plurality of fuel cells each including a tubular inner side electrode layer through which a fuel gas flows, an outer side electrode layer formed on the outer side of the inner side electrode layer along which an oxidant gas flows, and a solid electrolyte layer formed between the inner side electrode layer and the outer side electrode layer. The fuel gas is supplied from one end side of the plurality of fuel cells to the other end side, and a first fuel cell which is any one of the plurality of fuel cells, and a second fuel cell that is adjacent to the first fuel cell, are electrically connected by a first connection member and a second connection member. The first fuel cell has the first connection member disposed at the aforementioned other end side of the inner side electrode layer and the second connection member disposed at the aforementioned one end side of the inner side electrode layer. The second fuel cell has the first connection member disposed at the other end side of the outer side electrode layer and the second connection member disposed at the aforementioned one end side of the outer side electrode layer. The second connection member is disposed at a greater distance in the longitudinal axial direction measured from a terminal end of the aforementioned one end of the outer side electrode layer to a connection zone where the second connection member is connected, than the distance in the longitudinal axial direction measured from a terminal end of the other end side of the outer side electrode layer to a connection zone where the first connection member is connected. Accordingly, it is possible to mitigate the occurrence of electrical current concentration at the one end side (the upstream side in the fuel gas flow channel, i.e., the gas supply side) of the fuel cell, and to ensure durability of the fuel cell.

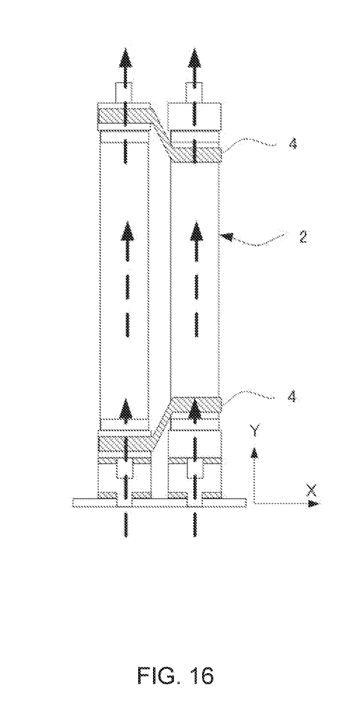

FIG. 16 illustrates a prior art double-end current collection structure in a plurality of tubular fuel cells contained in a fuel cell array. For the sake of simplicity, FIG. 16 shows only two connected fuel cells 2 among a plurality of fuel cells 2. Fuel gas (shown in the drawing with broken-line arrows) supplied from the lower end of the fuel cells to inside the internal flow channels (the fuel gas flow channels) is consumed in the electricity-generating reaction with the oxidant gas (not pictured) supplied from below the side surfaces of the fuel cells 2. The unreacted fuel gas is discharged from the upper ends of the fuel cells 2 to outside of the fuel cells. The fuel gas is a gas that is reformed outside of the fuel cell array, and it includes hydrogen. In the internal flow channels of the fuel cells 2, the farther up on the upstream side of the fuel gas flow channels (i.e., the lower end sides of the fuel cells), the higher the hydrogen concentration, and the farther down on the downstream sides of the fuel gas flow channels, the lower the hydrogen concentration in the downstream sides of the fuel gas flow channels, because it is consumed in the electricity-generating reaction. For this reason, the farther down in the lower end sides of the fuel cells 2, the greater the power generation in the electricity-generating reaction.

A connection member 4 is provided at an upper end portion and at a lower end portion of the fuel cells 2 in order to extract electrical current from the fuel cells 2. At the upper end portion and the lower end portion of the fuel cells 2, an inner side electrode layer (fuel electrode layer) is exposed. The connection member 4 is provided at the upper end portion and at the lower end portion respectively of the inner side electrode layer (fuel electrode layer) of the fuel cells 2 (the first fuel cell), electrically connecting to the outer side electrode layer (air electrode layer) of the adjacent fuel cell 2 (the second fuel cell) via the connection member 4. Accordingly, both the upper end portion and the lower end portion of the fuel cells 2 are electrically connected.

However, as described above, the lower end portion of the fuel cell is an area in which a zone where the power generation is high overlaps with a zone where electrical current is extracted by the connection member. Therefore, the occurrence of current concentration becomes prominent in the lower end portion of the fuel cell, and as a result, it was found that degradation of the lower end portion of the fuel cell is significant.

Therefore, according to the present invention, an electrical current extraction zone of the one end side of the fuel cell (i.e., the upstream side of the fuel gas flow channel) is disposed in greater proximity to the other end side of the fuel cell (i.e., the downstream side of the fuel gas flow channel) than in the prior art double-end current collection structure. The present inventors thought that this made it possible to solve the above-described problem by adjusting the electrical resistance in the axial direction of the fuel cell.

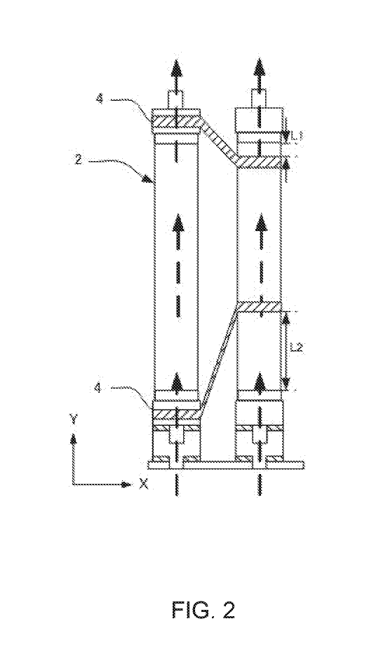

The current collection structure according to the fuel cell array of the present invention has a first fuel cell which is any one of the plurality of fuel cells and a second fuel cell that is adjacent to the first fuel cell are electrically connected by a first connection member and a second connection member. The first fuel cell has the first connection member disposed on the aforementioned other end side of the inner side electrode layer and the second connection member disposed at the aforementioned one end of the inner side electrode layer, The second fuel cell has the first connection member disposed at the aforementioned other end side of the outer side electrode layer and the second connection member disposed at the aforementioned one end of the outer side electrode layer. The second connection member is attached at a greater distance in the longitudinal axial direction measured from a terminal end of the aforementioned one end of the outer side electrode layer to a connection zone where the second connection member is connected, than the distance in the longitudinal axial direction measured from a terminal end on the other end side of the outer side electrode layer to a connection zone where the first connection member is connected. (See FIG. 2). Accordingly, it is possible to mitigate the occurrence of electrical current concentration in the lower end portion of the fuel cell, because the lower end side of the outer side electrode layer where the fuel gas is supplied has a zone where the power generation is high is separated away from a zone where electrical current is extracted by the connection member.

The fuel cell array according to the present invention is described with reference to FIG. 2. In FIG. 2, two fuel cells in a fuel cell array are electrically connected using two connection members. The broken like shows the flow of fuel gas. In the drawing, in the fuel cell on the left side (the first fuel cell), the first connection member is provided at the upper end side of the inner side electrode layer, and the second connection member is provided at the lower end side of the inner side electrode layer. In the fuel cell on the right side (the second fuel cell), the first connection member is provided at the upper end side of the outer side electrode layer, and the second connection member is provided at the lower end side of the outer side electrode layer. Specifically, the longitudinal axial distance (L2) measured from the terminal end portion of the lower end side of the outer side electrode layer of the second fuel cell to the connection zone where the second connection member is electrically connected is greater than the longitudinal axial distance (L1) measured from the terminal end portion of the upper end side of the outer side electrode layer of the second fuel cell to the connection zone where the first connection member is electrically connected.

“Connection zone” means a zone where the connection member and the outer side electrode layer are connected. The connection member and the outer side electrode layer may be electrically connected by direct contact, or they may be electrically connected by interposing a conductive layer between the collector layer and the outer side electrode layer. The conductive layer may be formed by applying a coating or paste containing a ceramic material, a metal, an alloy, or a mixture thereof and then curing.

“Longitudinal axial distance (L1) from the terminal end portion of the upper end side of the outer side electrode layer of the second fuel cell to the connection zone where the first connection member is electrically connected” means the shortest distance from the end portion of the other end side of the outer side electrode layer to the first connection member. Likewise, “longitudinal axial distance (L2) from the terminal end portion of the lower end side of the outer side electrode layer of the second fuel cell to the connection zone where the second connection member is electrically connected” means the shortest distance from the end portion of the lower end side of the outer side electrode layer to the second connection member.

In the present invention, the first connection member provided to the outer side electrode layer of the second fuel cell may be connected at a location at a specified distance from the terminal end of the other end side of the outer side electrode layer, or it may be uniformly connected to the other end side, or it may be connected while protruding from the terminal end so as to cover the terminal end of the other end side. In the present invention, “longitudinal axial distance from the terminal end portion of the upper end side of the outer side electrode layer of the second fuel cell to the connection zone where the first connection member is electrically connected” does not include zero.

According to the present invention, the second connection member is advantageously provided in the center portion in the axial direction of the outer side electrode layer of the second fuel cell, or at a location lower toward the lower end side of the fuel than the center portion. In cases where the outer side electrode layer is formed of composite layers as described below, it is advantageously provided in the center portion in the axial direction of the layer formed on the connection member side, or at a location lower toward the lower end side of the fuel than the center portion. The center portion in the axial direction of the outer side electrode layer is a location that is half the length of the axial direction of the outer side electrode layer.

Following is a description of the results of a simulation of current density of a prior art fuel cell array and a fuel cell array of the present invention.

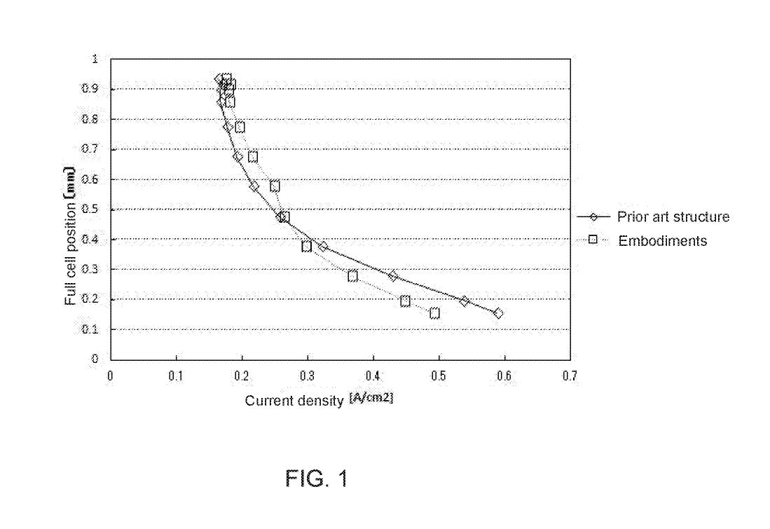

FIG. 1 is a graph illustrating the results of the simulation showing current density at height positions along a fuel cell. “Prior art structure” refers to a prior art double-end current collection structure, as shown in FIG. 16. “Embodiment” refers to a double-end current collection structure according to the present invention. In FIG. 1, the horizontal axis shows the current density of a single fuel cell. The vertical axis shows a height position along the fuel cell (relative position with respect to the entire length of the fuel cell). In the graph, 0 is the lower end of the fuel cell, and 1 is the upper end of the fuel cell. In the simulation, the conditions are identical except for the current collection structure, and the fuel gas is supplied from the lower end of the fuel cell (the part of FIG. 1 where the fuel cell position is 0).

As shown in FIG. 1, in the prior art structure, the closer the height position along the fuel cell is to the lower end (i.e., the more the fuel cell position approaches 0), the greater the current density. This indicates that current concentration occurs in the vicinity of the lower end of the fuel cell. By contrast, in the embodiments, current density where the fuel cell position is in the vicinity of 0 is low with respect to the prior art structure. Because of this, it is thought that in the embodiments, resistance increases as the position of the connection member (the site of current extraction) is further shifted away from the lower end side of the fuel cell. This is thought to mitigate the occurrence of current concentration.

Because of the above, while the present invention has a double-end current collection structure, the connection member provided on the lower end side of the fuel cell for extracting electrical current is shifted away from the lower end of the fuel cell where the electromotive force is high. This is thought to make it possible to avoid the problematic electrical current concentration at the lower end of the fuel cell, so as to produce a highly durable fuel cell array.

[Fuel Cell Array]

According to the present invention, the fuel cell array is an assembly wherein at least a plurality of fuel cells are physically immobilized by the connection member or a connecting means such as a seal. For example, this includes an entire structure in which a plurality of fuel cells are arrayed and anchored on a manifold for temporarily storing the fuel gas and distributing and supplying it to the fuel cells.

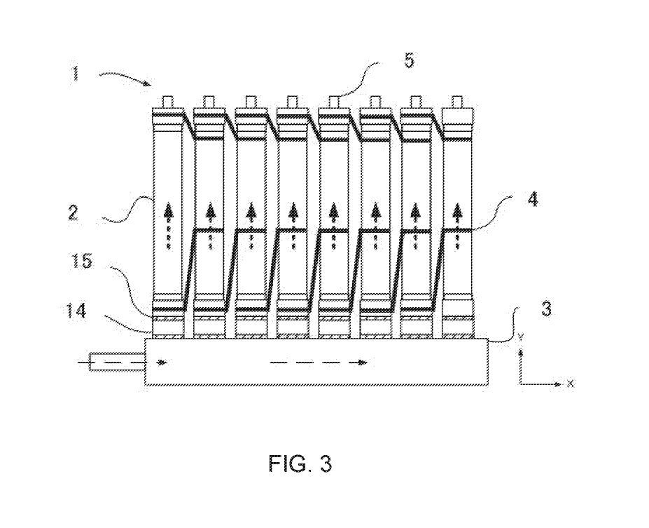

FIG. 3 illustrates a fuel cell array 1 that can be used in the present invention. As shown in FIG. 3, the fuel cell array 1 is formed from a plurality of tubular fuel cells 2 having gas flow channels inside them and a manifold 3. All of the fuel cells 2 are set up on the manifold 3. In this embodiment, the fuel cells 2 are supported and anchored by a glass 15. The fuel cells 2 are set up on the manifold 3 via an insulating support member 14 (also referred to as a bush), and sealed and anchored by the glass 15.

As shown by the broken-line arrows in the drawing, fuel gas is supplied from one end (the lower end) of the fuel cells 2, and the fuel gas (the hydrogen in the fuel gas) is consumed in the electricity-generating reaction. Fuel gas that is not used in generating electricity is discharged from the other end (the upper end) of the fuel cells. At the one end side of the fuel cell, the hydrogen concentration in the fuel gas is high. Because the fuel gas is consumed in the electricity-generating reaction as it proceeds downstream in the fuel gas flow channel, the fuel gas that is discharged from the other end of the fuel cell has a low hydrogen concentration.

The plurality of fuel cells 2 are electrically connected in series respectively by the connection members 4. Moreover, an electrical power extraction line (not pictured) is provided to the electrically connected fuel cells 2 at the one end side and the other end side of the conductive pathway in order to extract electrical power to the outside.

### [Connection Member]

In the present invention, the connection member is a conductive member used to electrically connect the fuel electrode layer of one fuel cell to the air electrode layer of an adjacent fuel cell, and it differs from a conductive film. It may be a single member (one part) or formed from a plurality of members, as long as the connection member can electrically connect fuel cells to each other.

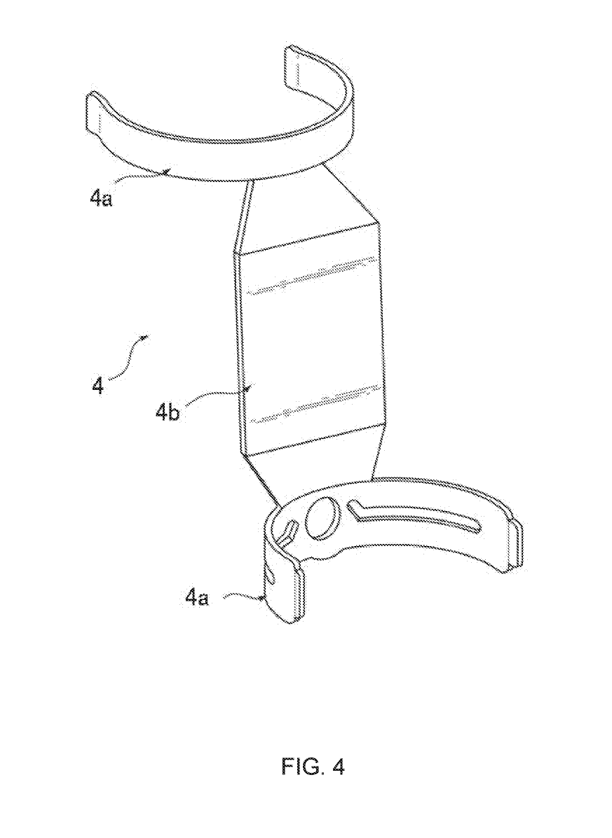

FIG. 4 shows a connection member that can be used in the present invention. As shown in FIG. 4, the connection member 4 advantageously includes two connecting portions 4a connecting to the outer side electrode layer and the inner side electrode layer of the fuel cells 2, and an extended portion 4b that electrically connects the two connecting portions 4a. The connection member 4 is preferably formed from a metal or an alloy. Specific examples include ferritic stainless steel, austenitic stainless steel, or the like. The surface of the connection member 4 may have a film such as a silver plating or the like.

In the present invention, it is advantageous to employ a connection member that is formed through a bending process to have integrally connected connecting portions 4a and extended portion 4b. It is even more advantageous to employ a connection member 4 having a surface on which is disposed a silver plating.

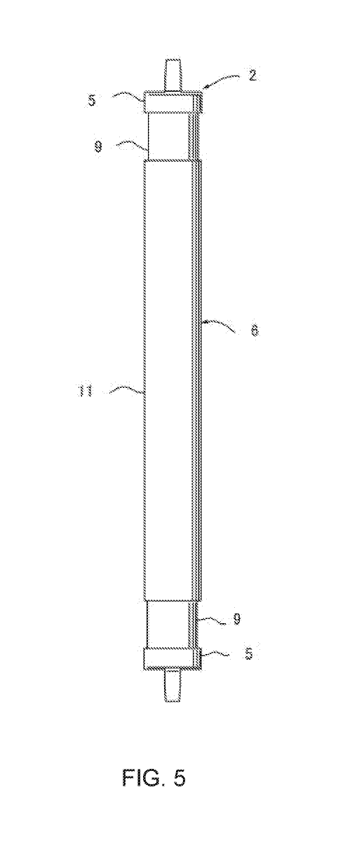

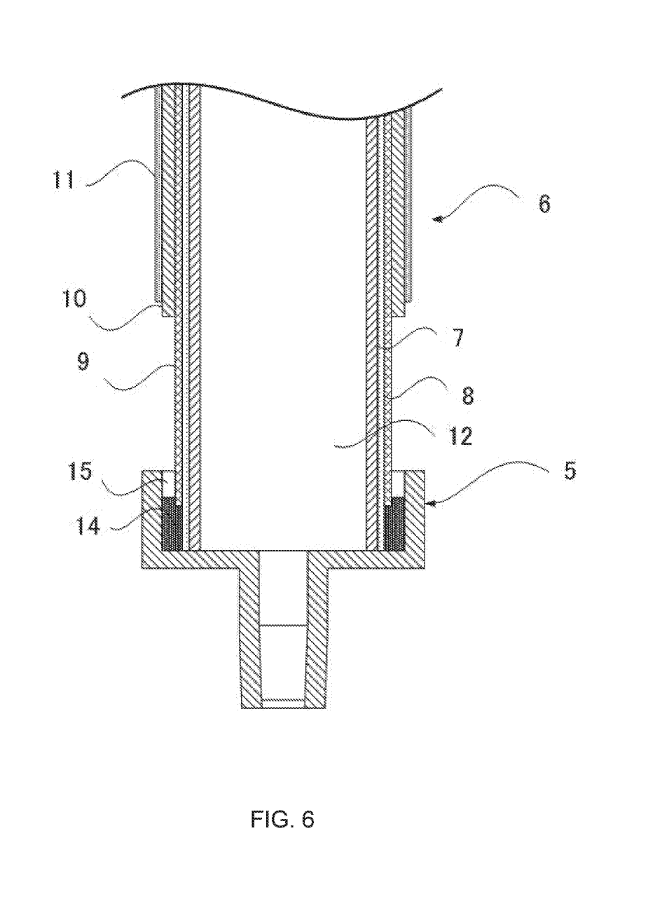

Following is a description of the fuel cell 2 according to the embodiment of the present invention, making reference to FIG. 5 and FIG. 6.

### [Fuel Cell]

According to the present invention, the fuel cell has an inner side electrode layer through which a fuel gas flows, an outer side electrode layer, formed on the outer side of the inner side electrode layer, along which an oxidant gas flows, and a solid electrolyte layer formed between the inner side electrode layer and the outer side electrode layer. In the present invention, the “inner side electrode layer” and the “outer side electrode layer” have at least the function of carrying out an electrochemical reaction between the supplied reaction gases. A conductive film (e.g., a film formed from a silver paste) may be applied on the surface of the electrodes to raise their conductivity so as to enhance the electricity-generating efficiency.

The fuel cell in the present invention has a tubular shape. According to the present invention, a tubular fuel cell means a fuel cell with a columnar shape having a longitudinal axial direction that extends in one direction (in the axial direction). This includes, for example, three-dimensional shapes such as circular cylinders, flattened cylinders, and other circular columns, as well as elliptical columns, rectangular columns, and the like. A gas flow channel may be provided within the fuel cell, and there may be a single gas flow channel or a plurality of gas flow channels.

FIG. 5 illustrates an example of the fuel cell 2 used in the embodiments of the present invention. A cap 5 (a metallic cap) is provided around the upper end portion and the lower end portion respectively of the fuel cell main body, and is electrically connected to the fuel electrode layer exposed at both end portions of the fuel cell. The cap 5 can be formed from a ferritic stainless steel or from an austenitic stainless steel. In this case, because an oxide of chromium is formed on the surface of the cap 5, the surface of the cap 5 may be coated with MnCo2O4 in order to prevent the evaporation of chromium.

The cap 5 and the fuel cell main body 6 are advantageously joined using a conductive material. For example, it is advantageous to join them by providing a silver wax between the cap 5 and the fuel cell main body 6.

The present specification describes embodiments having a current collection structure using caps, but caps are not required structures in the present invention, and current collection structures that do not use caps may be suitably implemented, as long as they do not deviate from the purport of the present invention.

### [Inner Side Electrode Layer]

According to the present invention, the inner side electrode layer is a fuel electrode. In the present invention, the fuel electrode includes a fuel electrode catalyst layer and a support member. For example, the fuel electrode layer may be a laminate of a fuel electrode conductive layer (a conductive support member) and a fuel electrode catalyst layer formed on the outer surface of the fuel electrode conductive layer, or a laminate of an insulating support member and a fuel electrode catalyst layer formed on the outer surface of the insulating support member. Additionally, the laminate structure may include a separately provided intermediate layer and a concentration gradient layer to enhance the functionality and durability of the fuel electrode layer.

The fuel electrode layer can be formed from at least one of (i) a mixture of zirconia doped with at least one species selected from Ni, Ca and Y, and a rare-earth element such as Y, Sc, or the like, (ii) a mixture of ceria doped with at least one species selected from Ni and a rare-earth element, and (iii) a mixture of lanthanum gallate doped with Ni and at least one species selected from Sr, Mg, Co, Fe, and Cu. For example, the fuel electrode layer 1101 may be Ni/YSZ.

If the fuel electrode layer is formed from composite layers, a fuel catalyst layer 8 may be formed on the outer circumference of a fuel electrode conductive layer formed from Ni/YSZ, for example. In the present invention, the fuel electrode conductive layer is advantageously formed from Ni/GDC.

### [Solid Electrolyte Layer]

A solid electrolyte layer 9 is advantageously formed from at least one species selected from a zirconia doped with at least one rare-earth element such as Y, Sc, or the like, a ceria doped with at least one species selected from the rare-earth elements Sr and Mg, and a lanthanum gallate doped with at least one species selected from Sr and Mg, for example. In the present invention, the solid electrolyte layer 9 is advantageously a lanthanum gallate oxide doped with Sr and Mg, and even more advantageously a lanthanum gallate oxide (LSGM) represented by the general formula La₁₋ₐSrₐGa_{1-b-c}Mg_{b}Co_{c}O₃ where 0.05≤a≤0.3, 0<b<0.3, and 0≤c≤0.15). The solid electrolyte layer may contain minute amounts of components other than the materials recited above.

The film thickness of the solid electrolyte layer is advantageously 1-100 μm, more advantageously 5-60 μm, and even more advantageously 10-50 μm. This makes it possible to obtain a film tenacity required during high-temperature operation and to obtain a high-performance electricity-generating capability.

### [Outer Side Electrode Layer]

In the present invention, the outer side electrode layer is an air electrode layer. The air electrode layer is formed across the entire outer peripheral surface of the fuel electrode layer with the solid electrolyte layer being held between the air electrode layer and the fuel electrode layer. In the present invention, the terminal end portion of the outer side electrode layer (the air electrode layer) refers to the end portions above and below the outer side electrode layer in the longitudinal axial direction of the fuel cell. Facing in the longitudinal axial direction of the fuel cell, the end portion at the lower side of the air electrode layer (the terminal end portion) is higher than the end portion at the lower side (the terminal end portion) of the fuel electrode layer 8, and the end portion of the of the upper side of the air electrode layer (the terminal end portion) is lower than the end portion of the upper side of the fuel electrode layer (the terminal end portion). In the present invention, the air electrode layer may be a single layer or composite layers. If the air electrode layer is composite layers, it may be a laminate having an air electrode layer an air electrode current collector layer on a surface of the air electrode layer.

The air electrode layer is formed from at least one species selected from a lanthanum manganite doped with at least one species selected from Sr and Ca, a lanthanum ferrite doped with at least one species selected from Sr, Co, Ni, and Cu, and a lanthanum cobaltite doped with at least one species selected from Sr, Fe, Ni, and Cu, or silver, or the like. The air electrode layer advantageously contains a perovskite oxide. The perovskite oxide can be one or more species selected from a lanthanum-cobalt-based oxide such as La₁₋ₓSrₓCoO₃ (where x=0.1-0.3) and LaCo₁₋ₓNiₓO₃ (where x=0.1-0.6), a lanthanum cobalt ferrite oxide (La₁₋ₘSrₘCo₁₋ₙ FeₙO₃ (where 0.05<m<0.50, and 0≤n≤1) which is a (La, Sr) FeO₃-based and (La, Sr) CoO₃-based solid solution, a samarium-cobalt-based oxide containing samarium and cobalt (Sm_{0.5}Sr_{0.5}CoO₃). A lanthanum strontium cobaltite ferrite (LSCF) is preferable.

If the air electrode layer is formed from composite layers, the air electrode conductive layer is advantageously formed on an outer periphery of the air electrode layer. The air electrode conductive layer may be formed from the same ceramic material as the air electrode layer, and specifically, the above-recited materials can be used. Alternatively, precious metals such as highly conductive Ag or Pd, platinum or alloys thereof may be used, or mixtures of ceramic materials and precious metals or alloys thereof can also be used. Specifically, the air electrode conductive layer can contain Ag and one or more species selected from the perovskite oxides recited above.

The film thickness of the air electrode layer is advantageously 10-1,000 μm, more advantageously 10-200 μm, and even more advantageously 10-150 μm. This makes it possible to obtain a high adhesion to the underlying layer and high fuel cell performance.

If the air electrode layer is formed from composite layers, the air electrode layer is advantageously 10-160 μm, more advantageously 10-45 μm, and even more advantageously 10-30 μm. The air electrode conductive layer is advantageously 10-1,000 μm, more advantageously 10-200 μm, and even more advantageously 10-150 μm.

FIG. 6 is a partial side view of a fuel cell that can be used in the present invention, and is a partial sectional view of the fuel cell 2 shown in FIG. 5. The fuel cell main body 6 is a pipe-like structure that extends in a vertical orientation. The fuel cell main body 6 has, as the fuel electrode layer, a cylindrical fuel electrode conductive layer 7 that forms a fuel gas flow channel 12 (also referred to as an internal flow channel) that serves as an internal gas channel, and a fuel electrode catalyst layer 8 provided on the outer periphery of the fuel electrode conductive layer 7. The fuel cell main body 6 has a cylindrical solid electrolyte layer 9 on an outer peripheral side of the fuel electrode catalyst layer 8. The fuel cell main body 6 also has a cylindrical air electrode layer 10 provided on the outer periphery of the solid electrolyte layer 9, and an air electrode conductive layer 11, which has electrical conductivity, provided on the outer periphery of the air electrode layer 10. The fuel electrode conductive layer 7 functions as a support member for the fuel cell main body 6, and it is also a porous body forming a gas channel for the fuel gas to flow internally. The cap 5 and the fuel cell main body 6 are joined by a silver 14 and a glass 15.

In the present invention, it is advantageous for the resistance on the upstream side of the fuel gas flow channel (i.e., the lower end side of the fuel cell) to be greater than the resistance on the downstream side of the fuel gas flow channel (i.e., the upper end side of the fuel cell). In the present invention, methods that can be used to cause the resistance to differ on the upper end side and the lower end side are described below.

(1) In the present invention, a method for causing a reaction resistance to differ at the upper end side and at the lower end side of the fuel cell is to cause a difference in resistance accompanying a reaction that generates electrons and ions in the outer side electrode layer and the inner side electrode layer (a reaction resistance).

In the present invention, a method for causing the reaction resistance to differ can involve using a material with a lower catalytic activity on the lower end side of the fuel cell than on the upper end side of the fuel cell.

For example, a difference in resistance between the lower end side and the upper end side in the outer side electrode layer can be obtained by using a material with a low electrode catalytic activity as the outer side electrode layer on the lower end side of the fuel cell, and using a material with a high electrode catalytic activity as the outer side electrode layer on the upper end side of the fuel cell. In an example of this method, the outer side electrode layer on the lower end side of the fuel side is formed from (La, Sr) MnO₃ or the like, and the outer side electrode layer on the upper end side of the fuel side is formed from (La, Sr) (Co, Fe) O₃) or the like.

Moreover, a method can be used whereby the reaction resistance is adjusted by mixing materials having oxide ion conductivity in the outer side electrode layer of the fuel cell. For example, if (La, Sr) MnO₃ is employed as the material of the outer side electrode layer of the fuel cell, mixing (Gd, Ce) O₂), a material having oxide ion conductivity, only in the outer side electrode layer on the upper end side of the fuel cell makes it possible to lower the reaction resistance.

Another method that can be used to obtain a difference in reaction resistance between the lower end side and the upper end side in the outer side electrode layer is to vary the ratio of the elements forming the outer side electrode layer at the lower end side of the fuel cell and the outer side electrode layer at the upper end side of the fuel cell. In an example of this method, the outer side electrode layer on the upper end side of the fuel cell is formed from (La_{0.6}, Sr_{0.4}) (CO_{0.2}, Fe_{0.8}) O₃), and the outer side electrode layer on the lower end side of the fuel cell is formed from (La_{0.6}, Sr_{0.4}) (Co_{0.8}, Fe_{0.2}) O₃).

In the present invention, the difference in reaction resistance between the upper end side and the lower end side of the fuel cell can involve determining the magnitude of the resistance of the fuel cell materials by evaluating the electrode catalytic activity. The electrode catalytic activity can be evaluated by measuring the alternating current impedance of the fuel cell that employs carious types of fuel cell materials, and measuring the magnitude of the arc components in a high frequency zone in a Cole-Cole plot.

(2) In the present invention, a specific method for increasing the resistance at the lower end side of the fuel cell over the resistance at the upper end side of the fuel cell involves causing a difference in the diffusion resistance of the gas and the air by creating a difference in the microstructure at the lower end side of the fuel cell and at the upper end side of the fuel cell.

In an example of this method, a difference in the resistance may be created by varying an air pore ratio between the inner side electrode layer at the lower end side of the fuel cell and the inner side electrode layer at the upstream side of the fuel cell. For example, the diffusion resistance of hydrogen and water vapor is raised by lowering the air pore ratio at the lower end side of the fuel cell.

The method for measuring the diffusion resistance involves measuring the magnitude of the arc components in a low frequency zone in a Cole-Cole plot. In accordance with JIS K 7126-1, diffusion resistance is obtained by using gas permeability as a substitute property, which is determined by applying a differential pressure to both sides of an electrode layer and measuring the amount of gas that permeates.

(3) In the present invention, a specific method for increasing the resistance at the lower end side of the fuel cell over the resistance at the upper end side of the fuel cell involves adjusting the resistance produced by the flow of electrons and ions. Specifically, a method of using a material with a lower conductivity ratio at the lower end side than at the upper end side of the fuel cell, i.e., a high resistance material can be used, or a method of creating different film thicknesses in the solid electrolyte layer and in the various electrode layers in the lower end side and in the upper end side of the fuel cell can be used.

In the present invention, the magnitude of the resistance produced by the flow of electrons and ions can be measured using the four-terminal method according to JIS C 2525 and JIS R 1661 and the like.

Making reference to the drawings, advantageous embodiments of the fuel cell array according to the present invention are described in detail.

### [Film Thickness of the Solid Electrolyte Layer]

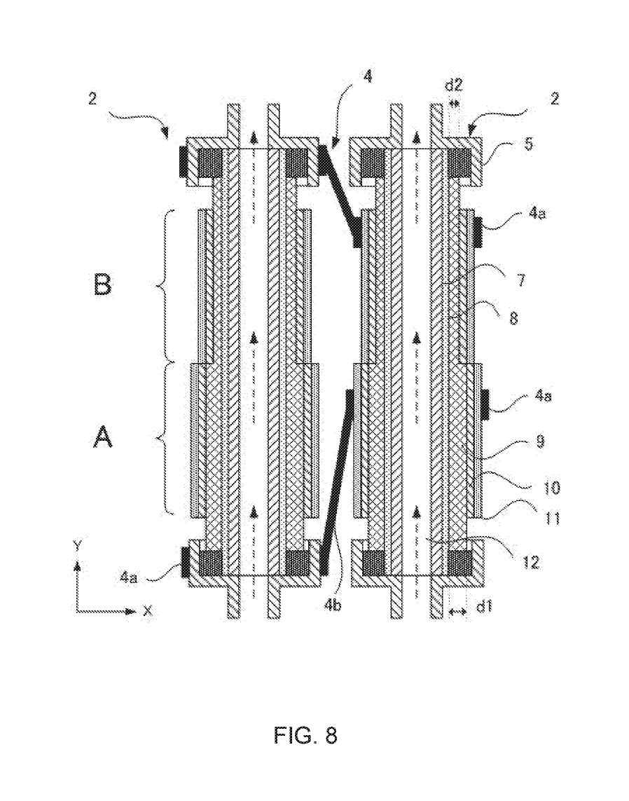

In the present invention, as shown in FIG. 8, a film thickness (d1) of the solid electrolyte layer 9 at the lower end side of the fuel cell is advantageously greater than a film thickness (d2) of the solid electrolyte layer 9 at the upper end side of the fuel cell. Because of this, the electrical resistance increases at the lower end side of the solid electrolyte layer 9. Therefore, it is possible to mitigate the concentration of current at the lower end side of the fuel cell, and also to enhance the durability of the fuel cell.

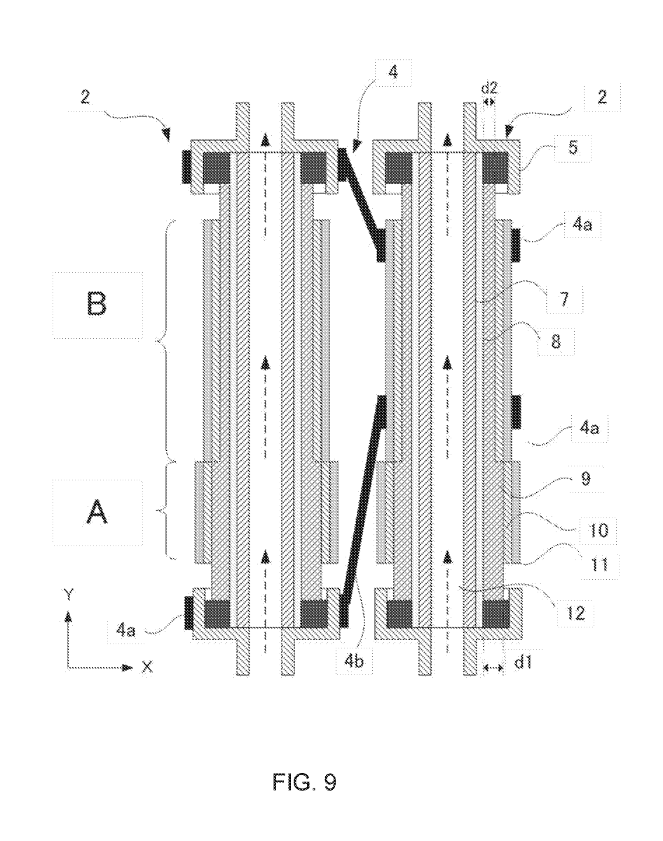

FIG. 8 and FIG. 9 illustrate this in detail. In the fuel cell 2, the solid electrolyte layer 9 has two zones—a zone in which the resistance at the lower end side is high (Zone A) and a zone in which the resistance at the upper end side is low (Zone B). In the solid electrolyte layer 9, the film thickness (d1) in Zone A is greater than the film thickness (d2) in Zone B. The solid electrolyte film 9 may be formed so that the film thickness continuously changes, having a film thickness gradient formed in such a manner that the film thickness of the solid electrolyte layer 9 gradually changes from one end to the other end in the longitudinal axial direction. Because the film thickness of the solid electrolyte layer 9 changes in FIG. 8 and FIG. 9, it appears that the air electrode 10 and the air electrode conductive layer 11 formed on the surface of the solid electrolyte layer 9 are divided by a boundary between Zone A and Zone B, but actually, they are formed continuously.

In the present invention, d2 is advantageously 1-50 μm, and more advantageously 1-30 μm, and even more advantageously 10-30 μm. Moreover, d1 and d2 satisfy the inequality d1≥d2.

In the present invention, the boundary between Zone A and Zone B is advantageously in the center portion in the axial direction of the outer side electrode layer, or at a location lower toward the lower end side of the fuel cell than the center portion.

According to the present invention, in the solid electrolyte layer 9, the resistance in Zone A is advantageously 1-fold to 2-fold that of the resistance in Zone B, and more advantageously 1-fold to 1.5-fold. Accordingly, in the solid electrolyte layer 9, the ion-conducting distance in the film thickness direction of the solid electrolyte layer is greater in the lower end side than in the upper end side, so the resistance is greater. Therefore, the occurrence of electrical current concentration is mitigated in the lower end side of the fuel cell.

According to the present invention, the connecting portion 4a of the connection member 4 (the first connection member) disposed in the upper end side of the fuel cell 2 is mounted in the low-resistance Zone B of the fuel cell 2 (the second fuel cell), and is advantageously electrically connected to the air electrode conductive layer 11 (the outer side electrode layer).

On the other hand, the connecting portion 4a of the connection member 4 (the second connection member) on the lower end side of the fuel side 2 may be provided in the high-resistance Zone A or in the low-resistance Zone B of the fuel cell 2 (the second fuel cell).

According to the present invention, the connecting portion 4a of the connection member 4 (the second connection member) at the lower end side of the fuel cell 2 is advantageously provided in Zone B of the fuel cell 2 (the second fuel cell). Accordingly, the conductive pathway is longer than if provided in Zone A, but a higher electricity-generating efficiency can be obtained because it in a low-resistance zone.

Moreover, the configuration is such that the extended portion 4b of the connection member 4 (the second connection member) at the lower end side of the second fuel cell 2 is longer than the extended portion 4b of the connection member 4 (the first connection member) at the higher end side of the fuel cell 2. For this reason, the longer the conductive pathway, the greater the resistance. It is therefore possible to limit the amount of current flowing through the connection member 4 (the second connection member) at the lower end side of the fuel cell 2. The length of the extended portion 9b may be suitably adjusted according to the resistance in the solid electrolyte layer 9.

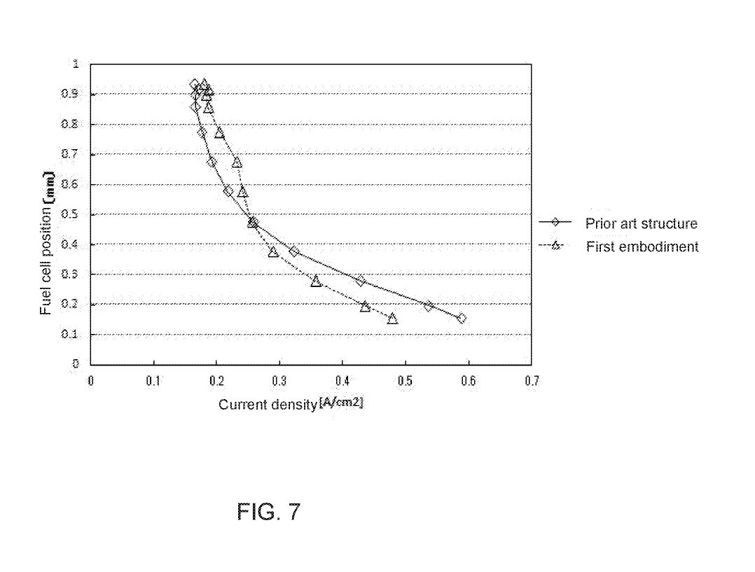

FIG. 7 is a plot showing simulation results for the double-end current collection structure of the prior art and for the current collection structure according to the first embodiment of the present invention, which shows simulation results for current density at height positions along the fuel cell. The horizontal axis indicates the current density of a single fuel cell, and the vertical axis indicates a height position along the fuel cell (the relative position with respect to the entire length of the fuel cell). The prior art double-end current collection structure has connection members disposed at both ends, as shown in FIG. 16. The first embodiment of the present invention employs a tubular fuel cell having a configuration such that the connection member is shifted away from the lower end of the fuel cell in the upper end direction in the axial orientation, and the solid electrolyte layer has a high film thickness at the lower end side of the fuel cell, and the fuel gas is supplied from the lower end of the fuel cell, as shown in FIG. 8. The conditions are identical, except for the current collection structure.

As shown in FIG. 7, in the prior art double-end current collection structure, the closer the height position along the fuel cell is to the lower end (i.e., the fuel gas upstream side near the supply port for the fuel gas), the greater the current density. This indicates that current concentration occurs in the vicinity of the lower end of the fuel cell. By contrast, in the current collection structure according to the first embodiment of the present invention, the current density is lower than in the prior art structure at a height position along the fuel cell close to the lower end. Moreover, when FIG. 1 and FIG. 7 are compared, it is found that the current density at the lower end is lower in this embodiment than in the first embodiment.

This is because according to the current collection structure in the first embodiment of the present invention, the resistance increases as the connection member is further shifted from the lower end of the fuel cell, so the solid electrolyte layer at the lower end side of the fuel cell has higher resistance than at the upper end side. Because of this, the ion conductive pathway becomes longer in the thickness direction of the solid electrolyte layer at the one end side of the fuel cell, so the resistance increases. Therefore, current collection at the one end side of the fuel cell can be further inhibited.

### [Film Thickness of the Electrode Layers]

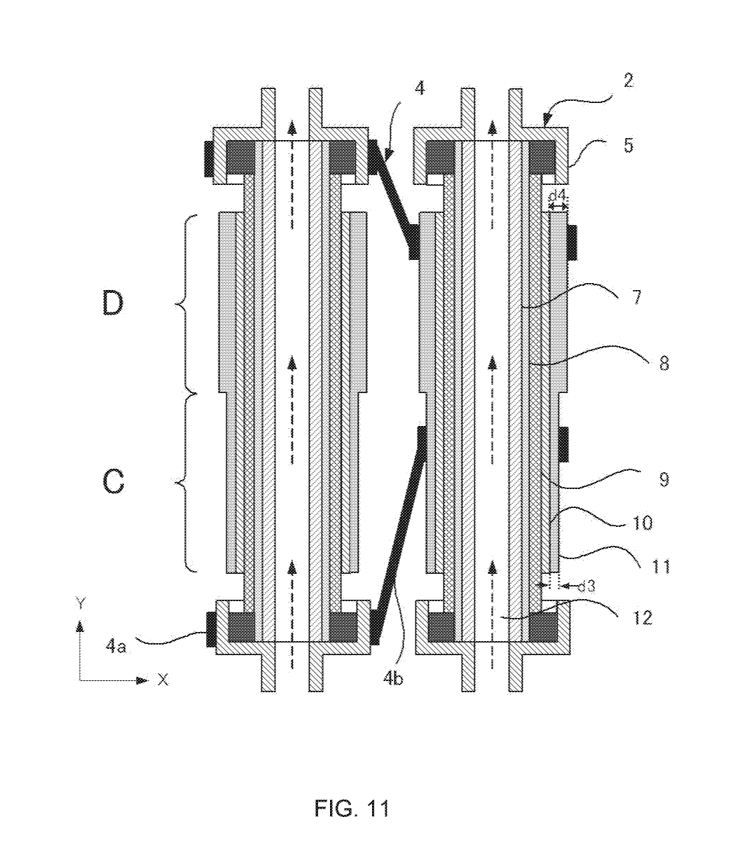

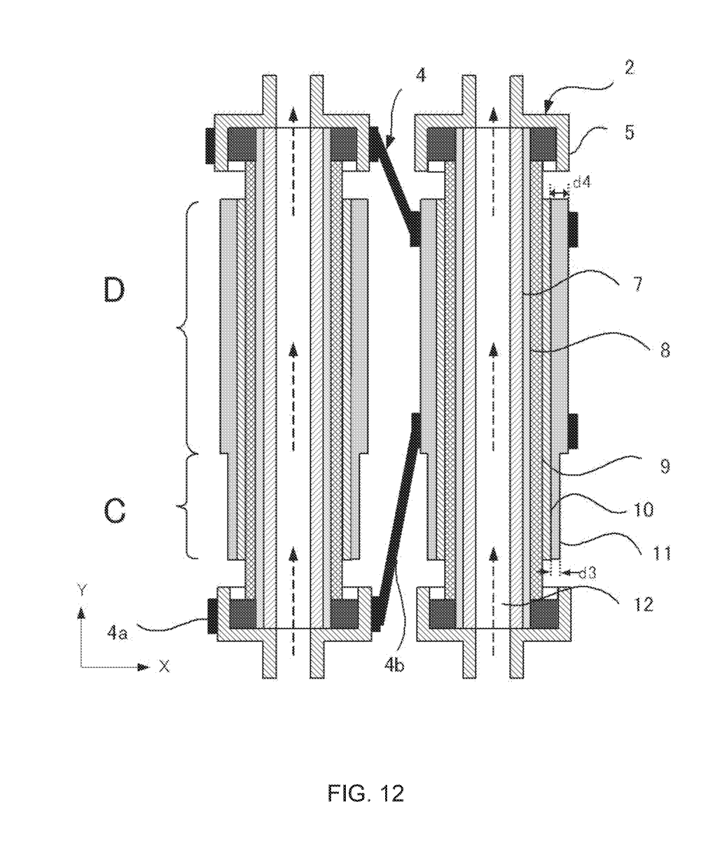

In the present invention, as shown in FIG. 11 and FIG. 12, the film thickness d3 of the air electrode layer at the lower end side of the fuel cell is advantageously less than the film thickness 4d of the air electrode layer on the upper end side of the fuel cell. That is to say, it is constructed so that the electrical resistance is higher at the one end side of the fuel cell in the conductive pathway in the axial direction of the air electrode conductive layer. Accordingly, current collection at the one end side of the fuel cell can be further mitigated. The resistance may be adjusted according to the film thickness of the air electrode layer, the fuel electrode layer, and the fuel electrode conductive layer, rather than the air electrode conductive layer.

FIG. 11 and FIG. 12 are now explained in detail. In the fuel cell 2, the air electrode conductive layer 11 has two zones—a zone in which the resistance at the lower end side is high (Zone C) and a zone in which the resistance at the upper end side is low (Zone D). In the air electrode conductive layer 11, the film thickness (d3) in Zone C is less than the film thickness (d4) in Zone D. The air electrode film 11 may be formed so that the film thickness continuously changes, having a film thickness gradient formed in such a manner that the film thickness of the air electrode film 11 gradually changes from the one end to the other end in the axial direction.

In the present invention, the boundary between Zone C and Zone D is advantageously in the center portion in the axial direction of the outer side electrode layer, or at a location lower toward the lower end side of the fuel cell than the center portion.

According to the present invention, the connecting portion 4a of the connection member 4 (the first connection member) disposed in the upper end side of the fuel cell 2 is mounted in the low-resistance Zone D of the fuel cell 2 (the second fuel cell), and is advantageously electrically connected to the air electrode conductive layer 11 (the outer side electrode layer).

The connecting portion 4a of the connection member 4 (the second connection member) on the lower end side of the fuel side 2 may be provided in the high-resistance Zone C or in the low-resistance Zone D of the fuel cell 2 (the second fuel cell). According to the present invention, it is more advantageous that the connecting portion 4a of the connection member 4 (the second connection member) on the lower end side of the fuel side 2 may be provided in Zone D. This makes it possible to inhibit the occurrence of current concentration at the lower end side of the fuel cell 2.

According to the present invention, in the air electrode conductive layer 11, the resistance in Zone C is advantageously 1.5-fold to 20-fold, and preferably 2-fold to 10-fold that of Zone D. Accordingly, the current flow at one end of the fuel cell can be controlled.

Moreover, the configuration is such that the extended portion 4b of the connection member 4 (the second connection member) at the lower end side of the second fuel cell 2 is longer than the extended portion 4b of the connection member 4 (the first connection member) at the higher end side of the fuel cell 2. Accordingly, the longer the conductive pathway, the greater the resistance. It is therefore possible to limit the amount of current flowing through the connection member 4 (the second connection member) at the lower end side of the fuel cell 2. The length of the extended portion 9b may be suitably adjusted according to the resistance in the solid electrolyte layer 11.

In cases where current concentration is mitigated by adjusting the inner side electrode layers (the fuel electrode conductive layer 7 and the fuel electrode layer 8), two zones are formed—a zone in which the resistance at the one end side of the fuel cell is high (Zone E), and a zone in which the resistance at the other end side of the fuel cell is low (Zone F). In such cases, it is desirable that the resistance in Zone E be 1-fold to 5-fold the resistance in Zone F. Accordingly, the current flow at the one end of the fuel cell can be controlled.

It is also advantageous to adjust the combined conductive resistance of the inner side electrode layers (the fuel electrode conductive layer 7 and the fuel electrode layer 8) and the outer side electrode layers (the air electrode layer 10 and the air electrode conductive layer 11) to mitigate current concentration at the lower end side of the fuel cell. Resistance at the lower end side of the fuel cell can also be adjusted by forming the upper half and lower half of the fuel cell in a vertically asymmetric configuration in the axial direction of the fuel cell. Examples of this include eliminating the air electrode conductive layer 11 at the one end side of the fuel cell, and increasing the resistance of the cap at the one end side of the fuel cell.

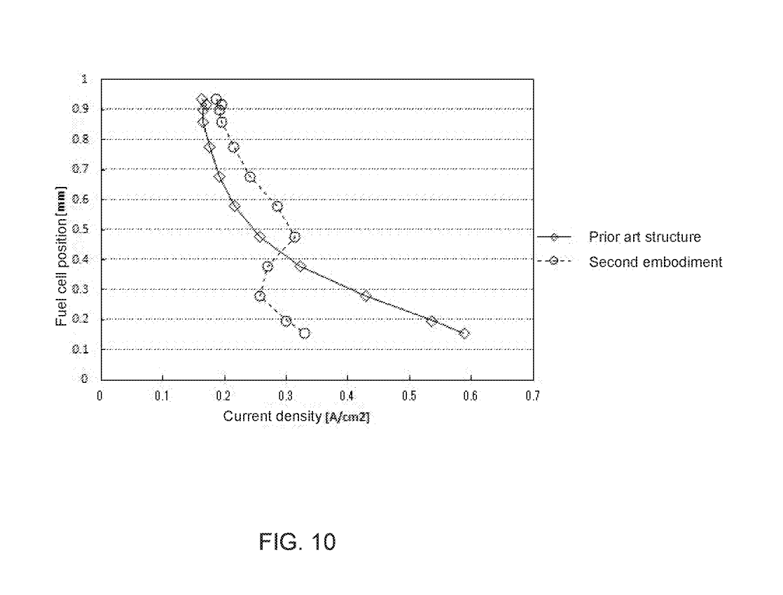

FIG. 10 is a plot showing simulation results for the double-end current collection structure of the prior art and for the current collection structure according to the second embodiment of the present invention, which shows simulation results for current density at height positions along the fuel cell. The horizontal axis indicates the current density of a single fuel cell, and the vertical axis indicates a height position along the fuel cell (the relative position with respect to the entire length of the fuel cell). The prior art double-end current collection structure has connection members disposed at both ends, as shown in FIG. 16. The second embodiment of the present invention employs a tubular fuel cell having a configuration such that the connection member is shifted away from the lower end of the fuel cell toward the upper end direction in the axial orientation, and the resistance of the air electrode conductive layer is made high at the lower end portion of the fuel cell. The fuel gas is supplied from the lower end of the tubular fuel cell, as shown in FIG. 10. The conditions are identical, except for the current collection structure.

As shown in FIG. 10, in the prior art double-end current collection structure, the closer the height position along the fuel cell is to the lower end (i.e., the fuel gas upstream side near the supply port for the fuel gas), the greater the current density. This indicates that current concentration occurs in the vicinity of the lower end of the fuel cell. By contrast, according to the second embodiment of the present invention, the current density at the lower end of the fuel cell is lower than in the prior art structure. Moreover, when FIG. 1 and FIG. 10 are compared, it is found that the current density at the lower end is lower in the second embodiment than in the first embodiment.

This is because in the fuel cell array according to the present invention as illustrated in FIG. 11 and FIG. 12, the resistance increases as the connection member is further shifted away from the lower end of the fuel cell, so the air electrode layer in the lower end side of the fuel cell has higher resistance than in the upper end side. Because of this, the flow of current at one end side of the fuel cell is mitigated, making it possible to further limit the current concentration at the one end side of the fuel cell.

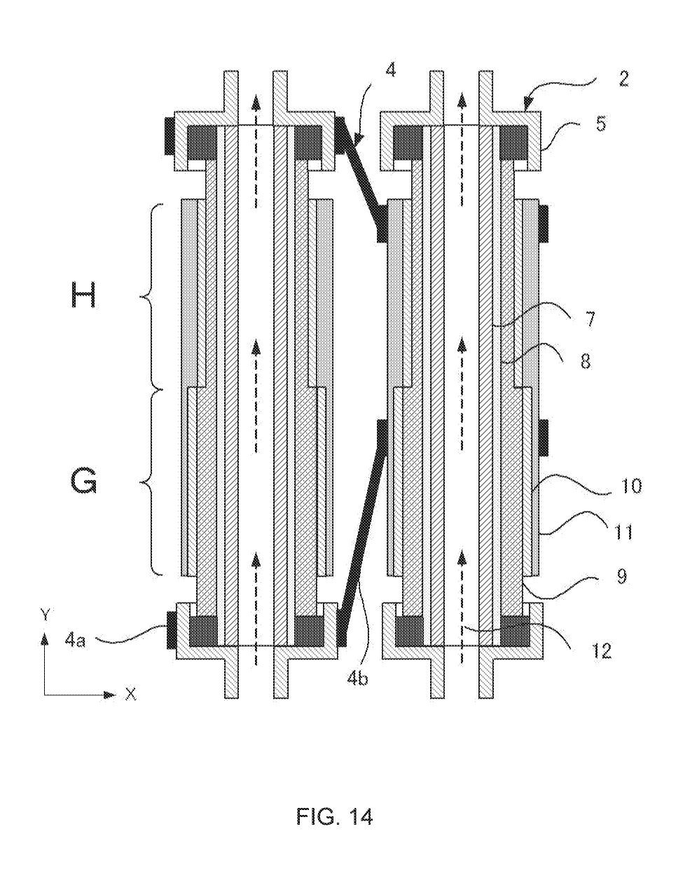

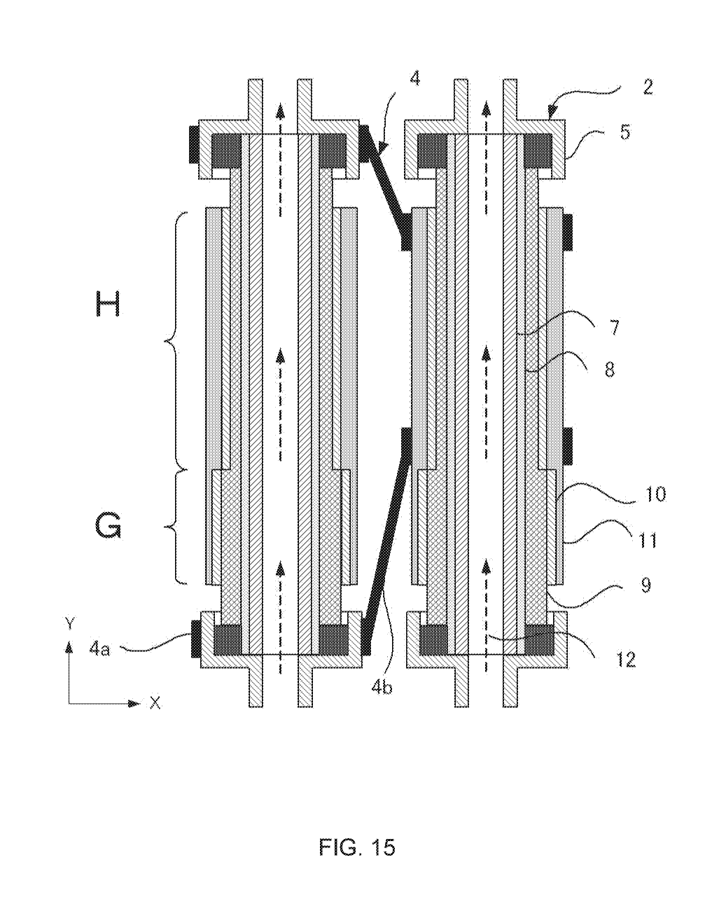

A specific method has been separately discussed above for increasing resistance at the lower end side over that of the upper end side of the fuel cell by creating different film thicknesses in the solid electrolyte layer or in the air electrode conductive layer It should be noted that these methods can be combined. Specifically, as shown in FIG. 14 and FIG. 15, according to the present invention, it is advantageous for the film thickness of the solid electrolyte film at the lower end side of the fuel cell to be greater than at the upper end side of the fuel cell, and for the film thickness of the air electrode conductive layer 11 at the lower end side of the fuel cell to be less than the film thickness of the air electrolyte conductive layer 11 at the upper end side. Accordingly, the fuel cell 2 has two zones—a zone in which the resistance at the lower end side is high (Zone G) and a zone in which the resistance at the upper end side is low (Zone H).

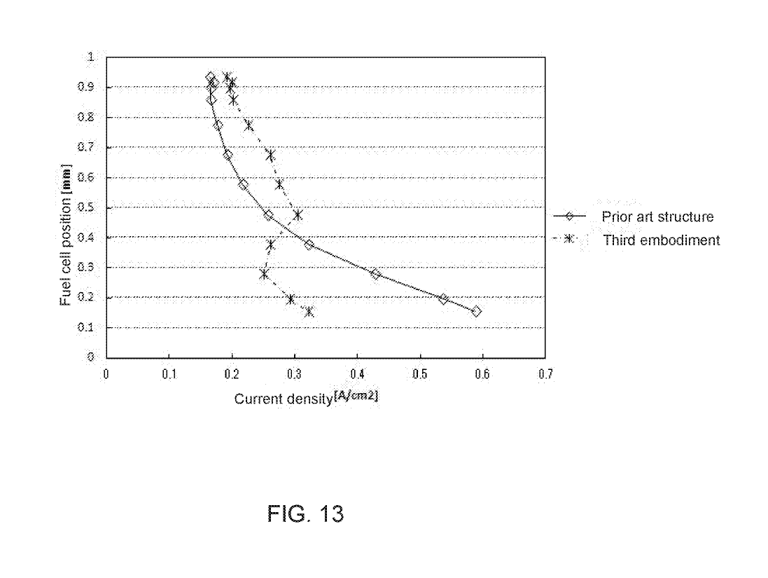

FIG. 13 is a plot showing simulation results for the double-end current collection structure of the prior art and for the current collection structure according to the second embodiment of the present invention, which shows simulation results for current density at height positions along the fuel cell. The prior art double-end current collection structure has connection members disposed at both ends, as shown in FIG. 16. The third embodiment of the present invention employs a tubular fuel cell having a configuration such that the connection member according to the present invention is shifted away from the lower end of the fuel cell toward the upper end in the axial orientation, and the resistances of the solid electrolyte layer and the air electrode conductive layer are made increased at the lower end portion of the fuel cell, and the fuel gas is supplied from the lower end of the fuel cell, as illustrated in FIG. 14 and FIG. 15. The conditions are identical, except for the current collection structure.

As shown in FIG. 13, in the prior art double-end current collection structure, the closer the height position along the fuel cell is to the lower end (i.e., the fuel gas upstream side near the supply port for the fuel gas), the greater the current density. This indicates that current concentration occurs in the vicinity of the lower end of the fuel cell. By contrast, according to the third embodiment of the present invention, the current density is lower than that of the prior art structure at a lower height position along the fuel cell. Moreover, when FIG. 1 and FIG. 13 are compared, it is found that the current density at the lower end is lower in the third embodiment than in the first embodiment.

This is because in the fuel cell array according to the present invention as illustrated in FIG. 14 and FIG. 15, the resistance increases as the connection member is further shifted away from the lower end of the fuel cell, so the solid electrolyte layer and the air electrode conductive layer have higher resistance at the upper end side than in the lower end side. Because of this configuration, the flow of current at the one end side of the fuel cell is mitigated, making it possible to further limit current collection at the lower end side of the fuel cell.

### EXAMPLES

### Manufacture of a Solid Oxide Fuel Cell

### Comparative Example 1

A fuel electrode support member was produced in a cylindrical shape by mixing a NiO powder and a 10YSZ (10 mol % Y₂O₃—90 mol % ZrO₂) powder in a weight ratio of 65:35, while imparting shear to form primary particles in an extruder. On this fuel electrode support member, a fuel electrode catalyst layer was formed for promoting the fuel electrode reaction. The fuel electrode catalyst layer was produced by mixing NiO and GDC10 (10 mol % Gd₂O₃—90 mol % CeO₂) in a weight ratio of 50:50, and forming a film on the fuel electrode support member by slurry coating. In addition, an LDC40 (40 mol % La₂O₃ —60 mol % CeO₂) and an LSGM composition of La_{0.8}Sr_{0.2}Ga_{0.8}Mg_{0.2}O₃ were successively laminated onto the fuel electrode catalyst layer by slurry coating, forming a solid electrolyte layer, resulting in a formed article. This formed article was sintered at 1300° C. After that, a slurry for an air electrode layer was formed into a film by slurry coating, and then sintered at 1050° to form an air electrode layer.

Next, an air electrode conductive layer was formed on the outer surface of the air electrode layer. The coating solution used to form the air electrode conductive layer was produced by mixing a silver powder, a palladium powder, an LSCF powder, a solvent, and a binder. The weight ratio of the silver, the palladium, and the LSCF was set at 98:1:1. After applying this coating solution to the surface of the air electrode layer using the ink jet method, it was dried in a dryer at 150° C., then cooled down to a room temperature, and subsequently sintered for 1 hour at 700° C. Accordingly, an air electrode conductive layer was formed on the outer surface of the air electrode layer. Fuel cells produced in this manner have the characteristics given in Table 1.

TABLE 1

| | | | | | | | | Air electrode | |
|---|---|---|---|---|---|---|---|---|---|
| | | | | | LSGM layer | | | conductive layer | |
| | | | | | Film | Film | | Film | Film |
| | | | | | thickness | thickness | | thickness | thickness |
| | | | | | on | on down- | | on | on down- |
| | | | | | upstream | stream | Air | upstream | stream |
| | Fuel electrode | | | | side of | side of | electrode | side of | side of |
| | support member | | Fuel electrode | LDC layer | fuel gas | fuel gas | layer | fuel gas | fuel gas |
| | Outer | | catalyst layer | Film | flow | flow | Film | flow | flow |
| | diam. | Thickness | Film thickness | thickness | channel | channel | thickness | channel | channel |
| | (mm) | (mm) | (μm) | (μm) | (μm) | (μm) | (μm) | (μm) | (μm) |
| Comp. Ex. | 10 | 1 | 20 | 5 | 30 | 30 | 20 | 30 | 30 |
| Example 1 | 10 | 1 | 20 | 5 | 30 | 30 | 20 | 30 | 30 |
| Example 2 | 10 | 1 | 20 | 5 | 50 | 30 | 20 | 30 | 30 |
| Example 3 | 10 | 1 | 20 | 5 | 30 | 30 | 20 | 30 | 50 |
| Example 4 | 10 | 1 | 20 | 5 | 50 | 30 | 20 | 30 | 50 |

### Manufacture of a Solid Oxide Fuel Cell Array

A fuel cell unit was produced by attaching a conductive sealing material, which functions as a current collector and a gas seal, to both end portions of the fuel electrode support member of each fuel cell, and providing an inner side electrode terminal to cover the conductive sealing material at both end portions of the fuel electrode. The inner side electrode terminal has a reduced diameter portion that is smaller in diameter than the inner diameter of the fuel electrode support member and extends outward from the end portion of each respective fuel cell. Sixteen fuel cell units were electrically connected in series by the connection members, so as to produce a solid oxide fuel cell array. The connection member had connecting portions of the type shown in FIG. 4 for electrically connecting the air electrode layers of each fuel cell and an extended portion 4b that electrically connects the connecting portions. As shown in FIG. 16, the two connection members were provided at the two end portions of two adjacent fuel cells.

### Durability Testing of the Solid Oxide Fuel Cell Array

Durability tests were performed using the solid oxide fuel cell arrays that were produced. A mixture of hydrogen and nitrogen was used as the fuel gas, and the fuel usage rate was set at 75%. Air was used as the oxidant gas, and the air usage rate was set at 40%. The electricity-generation operation temperature was set at 700° C., and the current density, obtained by dividing the current value by the surface area of the air electrode, was set at 0.2 Acm⁻². The fuel cell array was continuously operated for about 1,000 hours. Table 2 shows the local maximum current density and the voltage decay rate during continuous operation both obtained by simulation.

TABLE 2

| | Maximum Current Density | Voltage Decay Rate |
|---|---|---|
| | (Acm⁻²) | (%) |
| Comparative Example | 0.59 | 0.5 |
| Example 1 | 0.49 | 0.2 |
| Example 2 | 0.48 | 0.2 |
| Example 3 | 0.32 | 0 |
| Example 4 | 0.32 | 0 |

### Example 1

Fuel cells having the same characteristics as shown in Table 1 were produced using the same method as used to produce the Comparative Example. The fuel cell units were produced by the same method as used to produce Comparative Example 1, except that the extended portion of the connection member provided on the lower end side of the fuel cell (the upstream side of the fuel gas flow channel) is longer than the extended portion of the connection member provided on the upper end side of the fuel cell (the downstream side of the fuel gas flow channel), as shown in FIG. 2, and the position of the connection member provided on the lower end side (the upstream side of the fuel gas flow channel) of one of two adjacent fuel cells is set in the vicinity of the center portion in the axial direction of the fuel cell. After that, durability testing of the same type as used in Comparative Example 1 was carried out. The results are given in Table 2.

### Example 2

Fuel cells and fuel cell units were produced by the same method as in Example 1, except that the thickness of the LSGM layer at the lower end side of the fuel cell (the upstream side of the fuel gas flow channel) was made thicker than the thickness of the LSGM layer at the other end side of the fuel cell (the downstream side of the fuel gas flow channel), as shown in Table 1. Along the length of the axial direction of the LSGM layer, the diverging point of thickness is set at a position such that the length at the lower end side of the fuel cell: the length at the upper end side of the fuel cell=1:2. After that, durability testing of the same type as used in Comparative Example 1 was carried out. The results are given in Table 2.

### Example 3

Fuel cells and fuel cell units were produced by the same method as in Example 1, except that the thickness of the air electrode conductive layer at the other end side of the fuel cell (the downstream side of the fuel gas flow channel) was made thicker than the thickness of the air electrode conductive layer at one end side of the fuel cell (the upstream side of the fuel gas flow channel) as shown in Table 1. Along the length of the axial direction of the LSGM layer, the diverging point of thickness is set at a position such that the length at the lower end side of the fuel cell: the length at the upper end side of the fuel cell=1:2. After that, durability testing of the same type as used in Comparative Example 1 was carried out. The results are given in Table 2.

### Example 4

Fuel cells and fuel cell units were produced by the same method as in Example 2, except that the thickness of the air electrode conductive layer at the other end side of the fuel cell (the downstream side of the fuel gas flow channel) was made thicker than the thickness of the air electrode conductive layer at one end side of the fuel cell (the upstream side of the fuel gas flow channel) as shown in Table 1. Along the length of the axial direction of the LSGM layer, the diverging point of thickness is set at a position such that the length at the lower end side of the fuel cell: the length at the upper end side of the fuel cell=1:2. After that, durability testing of the same type as used in Comparative Example 1 was carried out. The results are given in Table 2.

### EXPLANATION OF THE REFERENCE SYMBOLS

1. Fuel cell array
2. Fuel cell
3. Manifold
4. Connection member (first connection member, second connection member)
4a Connecting portion
4b. Extended portion
5. Cap (metallic cap)
6. Fuel cell main body
7. Fuel electrode conductive layer
8. Fuel electrode layer
9. Electrolyte layer
10. Air electrode layer
11. Air electrode conductive layer
12. Fuel gas flow channel
14. Insulating support member
15 Glass
A. Zone A
B. Zone B
C. Zone C
D. Zone D
G. Zone G
H. Zone H

1-9. (canceled)

10. A solid oxide fuel cell array comprising:
(a) a plurality of tubular fuel cells, each fuel cell extending in a longitudinal direction and having a supply end at one longitudinal end and a discharge end at the other longitudinal end, wherein the fuel gas flows inside the fuel cell from the supply end of the fuel cell toward the discharge end of the fuel cell, each fuel cell comprising:
an inner side electrode layer extending in the longitudinal direction along the fuel cell, wherein the fuel gas flows through inside of the inner side electrode layer;
an outer side electrode formed over the inner side electrode layer, wherein an oxidant gas flows along the outer side electrode layer, the outer side electrode layer extending in the longitudinal direction along the fuel cell and having a supply side terminal end on a side of the supply end of the fuel cell and a discharge side terminal end on a side of the discharge end of the fuel cell; and
a solid electrolyte layer formed between the inner side electrode layer and the outer side electrode layer; and
(b) a first connection member and a second connection member configured to electrically connect two adjacent first and second fuel cells to electrically connect the plurality of fuel cells in series, wherein
the first fuel cell has the first connection member connected to the inner side electrode layer of the first fuel cell near the discharge end of the first fuel cell and has the second connection member connected to the inner side electrode layer of the second fuel cell near the supply end of the second fuel cell,
the second fuel cell has the first connection member connected to the outer side electrode layer of the second fuel cell at a discharge side distance measured from the discharge side terminal end of the outer side electrode layer of the second fuel cell and has the second connection member connected to the outside side electrode layer of the second fuel cell at a supply side distance measured from the supply side terminal end of the outer side electrode of the second fuel cell, and
the supply side distance is longer than the discharge side distance.

11. The solid oxide fuel cell array according to claim 10, wherein the second fuel cell has the second connection member connected to the outer side electrode layer of the second fuel cell either in a center portion of the second fuel cell in the longitudinal direction or at a position shifted from the center portion of the second fuel cell toward the supply end of the second fuel cell.

12. The solid oxide fuel cell array according to claim 10, wherein the first and second connector members each comprise a pair of connecting portions configured to electrically connect, respectively, to the inner side electrode layer of the first fuel cell and the outer side electrode layer of the second fuel cell, the first and second connector members each further comprising a bridge portion configured to electrically connect the pair of connecting portions, wherein the bridge portion of the second connector member is longer than the bridge portion of the first connector member.

13. The solid oxide fuel cell array according to claim 10, wherein the inner side electrode layer of the fuel cell has a greater resistance on a side of the supply end of the fuel cell than on a side of the discharge end of the fuel cell.

14. The solid oxide fuel cell array according to claim 13, wherein the inner side electrode layer of the fuel cell has a resistance on the side of the supply end of the fuel cell of at least 1.0-fold and less than 5-fold the resistance on the side of the discharge end of the fuel cell.

15. The solid oxide fuel cell array according to claim 10, wherein the outer side electrode layer of the fuel cell has a greater resistance on a side of the supply end of the fuel cell than on a side of the discharge end of the fuel cell.

16. The solid oxide fuel cell array according to claim 15, wherein the outer side electrode layer of the fuel cell has a resistance on the side of the supply end of the fuel cell of at least 1.5-fold and less than 20-fold the resistance on the side of the discharge end of the fuel cell.

17. The solid oxide fuel cell array according to claim 10, wherein the solid electrolyte layer of the fuel cell has a greater resistance on a side of the supply end of the fuel cell than on a side of the discharge side of the fuel cell.

18. The solid oxide fuel cell array according to claim 17, wherein the solid electrolyte layer of the fuel cell has a resistance on the side of the supply end of the fuel cell of at least 1 fold and less than 2-fold the resistance on the side of the discharge end of the fuel cell.

19. The solid oxide fuel cell array according to claim 10, wherein the outer side electrode layer of the fuel cell comprises a supply side area extending in the outer side electrode layer on a side of the supply end of the fuel cell and a discharge side area extending in the outer side electrode layer on a side of the supply end of the fuel cell, the outer side electrode layer of the fuel cell has a film thickness (d3) in the supply side area and a film thickness (d4) in the discharge side area, wherein the film thickness (d3) and the film thickness (d4) satisfy inequality of d4>d3.

20. The solid oxide fuel cell array according to claim 10, wherein the solid electrolyte layer of the fuel cell comprises a supply side area extending in the solid electrolyte layer on a side of the supply end of the fuel cell and a discharge side area extending in the solid electrolyte layer on a side of the supply end of the fuel cell, the solid electrolyte layer of the fuel cell has a film thickness (d1) in the supply side area and a film thickness (d2) in the discharge side area, wherein the film thickness (d1) and the film thickness (d2) satisfy inequality of d1>d2.
